(19) United States
(12) Patent Application Publication
(10) Pub. No.: US 2022/0034830 A1
(43) Pub. Date: Feb. 3, 2022

(54) PASSIVE REFERENCE OBJECT FOR THERMOGRAPHIC CAMERA

(71) Applicant: RealNetworks, Inc., Seattle, WA (US)

(72) Inventor: Milko Boic, Seattle, WA (US)

(21) Appl. No.: 16/983,918

(22) Filed: Aug. 3, 2020

(51) Int. Cl. G01N 25/20; G01J 5/04

(52) U.S. Cl. CPC G01N 25/20; G01J 2005/0085; G01J 5/04

(57) ABSTRACT

A system for determining the temperature of a subject includes a thermographic camera and a passive reference object fixedly positioned relative to the thermographic camera with at least a portion of the reference object in a line of sight of the camera. In operation, the system captures temperature information of a subject and the reference object using the thermographic camera. The reference object has known physical properties, such that the reference object can be used as a base line for the system to determine fluctuations in the temperature information. The fluctuations are then removed from the temperature information of the subject to increase an accuracy of the temperature reading of the subject.

### BACKGROUND

### Technical Field

The present disclosure relates to systems and methods for improving the accuracy of thermographic cameras.

### Description of the Related Art

Devices, systems, and methods for determining the temperature of a subject are known. For example, cameras have been developed to determine the temperature of a subject using an array of heat sensors. However, known sensors and other devices for determining temperature are known to be inaccurate because of localized and environmental temperature fluctuations that distort temperature readings. In other words, operation of known thermographic cameras produces heat, which is picked up by the heat sensors. This additional heat from operation of the camera distorts the temperature readings of the sensors and results in inaccurate temperature measurements of the subject. Further, environmental conditions such as a change in the temperature of the operating environment of the thermographic camera can have a similar impact. For example, if a thermographic camera is used in a first location with an environmental temperature of 25 degrees Celsius and is then moved and used in a temperature controlled room at 15 degrees Celsius, the sudden change in environmental temperature will distort the temperature readings of the subject by the thermographic camera.

In response, thermographic cameras have been developed with temperature controlled or cooled sensors to reduce the error in the temperature readings that is attributable to operation of the camera. However, such devices require additional power and are expensive, which limits their use. Further, such devices have additional fragile components that are prone to breaking or damage and therefore reduce the useful life of the system. In un-cooled solutions, the thermographic cameras are calibrated to reduce errors. However, un-cooled cameras suffer from sensor drift that results in inaccuracies over time and the need for frequent calibration, which disrupts use of the device. Some cameras use an actively controlled external temperature source for calibration, or “black body.” However, black bodies are expensive and bulky and require power for temperature control, which introduces additional complexities into the system and increases cost.

### BRIEF SUMMARY

The present disclosure is directed to system, devices, and methods that overcome some or all of the disadvantages of known thermographic cameras by utilizing a passive reference object for calibration of a thermographic camera in combination with processor-executable instructions that determine temperature fluctuations based on known properties of the reference object and correct the measured temperature of a subject based on the determined temperature fluctuations.

More specifically, in at least some implementations a system includes a housing or case with a base, an extension element coupled to the base, and a first opening between the base and the extension element. The system further includes a cover coupled to extension element with a second opening between the cover and the extension element. The first opening receives a thermographic camera and the second opening receives a passive reference object. The housing holds the reference object at least partially in a line of sight of the thermographic camera. The system further includes one or more processors and non-transitory memory storing a set of instructions that, when executed by the one or more processors, cause the system to activate the camera and simultaneously obtain temperature readings of a subject and the reference object. The instructions further cause the system to determine a fluctuation in temperature that is common to the first and second temperatures based on known properties of the reference object. In other words, the reference object has properties that resist temperature changes, such that fluctuations in temperature of the reference object can be identified by the system. Once a fluctuation has been determined, the fluctuation is subtracted or removed from the temperature reading of the subject to eliminate distortion and improve accuracy.

One or more implementations of a device include: a case, including a reference object coupled to the case, and a portion of the case spaced from the reference object by a fixed distance, wherein the portion of the case is configured to receive a thermographic camera with at least a portion of the reference object in a line of sight of the thermographic camera.

The device may further include: a base, an extension element coupled to the base, wherein the base and the extension element define a first opening, and a cover coupled to the extension element, wherein the cover and the extension element define a second opening, wherein the first opening is configured to receive the thermographic camera and the second opening is configured to receive the reference object; the base and the cover each including at least one of a plurality of connectors, each of the plurality of connectors including a protrusion and a flange extending transverse to the protrusion; the extension element further including a plurality of apertures configured to receive the plurality of connectors to selectively couple the base and the cover to the extension element; the fixed distance being between 5 and 15 centimeters; the reference object being passive; and the portion of the reference object positioned in the line of sight of the thermographic camera corresponding to between 20 and 60 pixels of an array of the thermographic camera.

One or more implementations of a system include: a housing; a thermographic camera coupled to the housing and having a line of sight; a reference object coupled to the housing with at least a portion of the reference object positioned in the line of sight of the thermographic camera; one or more processors; and non-transitory memory storing a set of instructions that, as a result of execution by the one or more processors, cause the system to activate the thermographic camera, obtain, with the thermographic camera, a first temperature of a subject, obtain, with the thermographic camera, a second temperature of the reference object, analyze the second temperature based on a known property of the reference object to generate an adjusted first temperature of the subject, and output the adjusted first temperature of the subject.

The system may further include: the instructions to analyze the second temperature further including instructions to determine a fluctuation in the second temperature based on the known property of the reference object and adjust the first temperature in real time based on the fluctuation to generate the adjusted first temperature of the subject; the second temperature being one a plurality of second temperatures, and the non-transitory memory stores further instructions that, as a result of execution by the one or more processors, causes the system to determine an average of the plurality of second temperatures over a period of time, identify, using the average of the plurality of second temperatures, a plurality of fluctuations in the plurality of second temperatures over the period of time, determine an exponential moving average of the plurality of fluctuations during the period of time, adjust the first temperature of the subject based on a trend line fit to the exponential moving average of each of the plurality of fluctuations.

The system may further include: a temperature sensor coupled to the one or more processors that is configured to detect environmental temperature, and the non-transitory memory stores further instructions that, as a result of execution by the one or more processors, causes the system to identify changes in the environmental temperature over time based on temperature signals received from the temperature sensor, and adjust the first temperature and the second temperature based on identified changes in the environmental temperature; the reference object being spaced from the thermographic camera by a distance between 2 centimeters and 10 centimeters; the portion of the reference object positioned in the line of sight of the thermographic camera corresponding to between 20 and 60 pixels of an array of the thermographic camera; and the housing further including a base having a first connector, an extension element coupled to the base, the extension element having a first aperture and a second aperture, the first connector received in the first aperture, wherein the extension element and the base define a first opening with the thermographic camera received in the first opening, and a cover coupled to the extension element, the cover having a second connector received in the second aperture of the extension element, wherein the cover and the extension element define a second opening with the reference object received in the second opening.

One or more implementations of a method include: activating a thermographic camera; capturing, with the thermographic camera, a first temperature of a subject; capturing, with the thermographic camera, a second temperature of a reference object; analyzing the second temperature based on a known property of the reference object to generate an adjusted first temperature of the subject; and outputting the adjusted first temperature.

The method may further include: the analyzing the second temperature including determining a fluctuation in the second temperature compared to an average of the second temperature over a period of time, and adjusting the first temperature based on the determined fluctuation to generate the adjusted first temperature of the subject; and capturing the second temperature includes capturing a plurality of second temperatures, the method further comprising determining an average of the plurality of second temperatures during a period of time, identifying a plurality of fluctuations in the plurality of second temperatures relative to the average over the period of time, determining an exponential moving average for the plurality of fluctuations over the period of time, and adjusting the first temperature of the subject based on a trend line fit to the exponential moving average of each of the plurality of fluctuations.

The method may further include: after identifying the plurality of fluctuations in the plurality of second temperatures, applying an attenuation factor to the plurality of fluctuations based on a difference between the first temperature and the average of the plurality of second temperatures; capturing the first temperature of the subject including capturing the first temperature after a warm-up time period following activating the thermographic camera; and capturing the first temperature including capturing temperature data corresponding to a first area of the subject and capturing the second temperature includes capturing temperature data corresponding to a second area of the reference object, wherein the first area and the second area are approximately equal.

### BRIEF DESCRIPTION OF THE SEVERAL VIEWS OF THE DRAWINGS

For a better understanding of the embodiments, reference will now be made by way of example only to the accompanying drawings. In the drawings, identical reference numbers identify similar elements or acts. In some figures, the structures are drawn to scale. In other figures, the sizes and relative positions of elements in the drawings are not necessarily drawn to scale. For example, the sizes, shapes of various elements and angles may be enlarged and positioned in the figures to improve drawing legibility.

FIG. 1 is a perspective view of a system with a thermographic camera and a reference object coupled to a case with the reference object in a line of sight of the camera according to the present disclosure.

FIG. 2 is an exploded perspective view of the case of FIG. 1.

FIG. 3 is a perspective view of a cover of the case of FIG. 1.

FIG. 4 is a perspective view of an extension element of the case of FIG. 1.

FIG. 5 is a perspective view of a base of the case of FIG. 1.

FIG. 6A is a perspective view of a use configuration of the system of FIG. 1.

FIG. 6B is an elevational view of the use configuration of FIG. 6A from a point of view of the thermographic camera.

FIG. 7 is a top plan view of the thermographic camera of the system of FIG. 1 illustrating a sensor array of the thermographic camera.

FIG. 8 is a schematic representation of an embodiment of a controller in electronic communication with a thermographic camera according to the present disclosure.

FIG. 9 is a diagram of an embodiment of a start-up and operation process of a thermographic camera according to the present disclosure.

FIG. 10 is a diagram of an embodiment of an algorithm for determining temperature fluctuations in a temperature reading and correcting temperature measurements of a subject based on the determined fluctuations according to the present disclosure.

### DETAILED DESCRIPTION

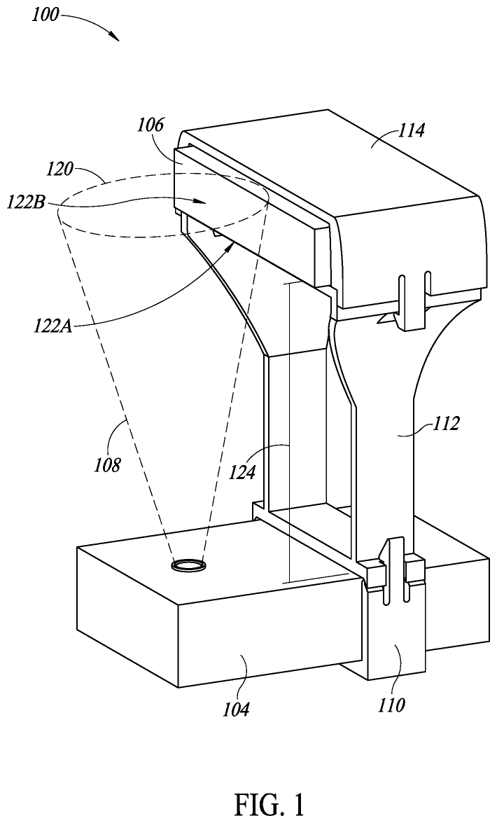

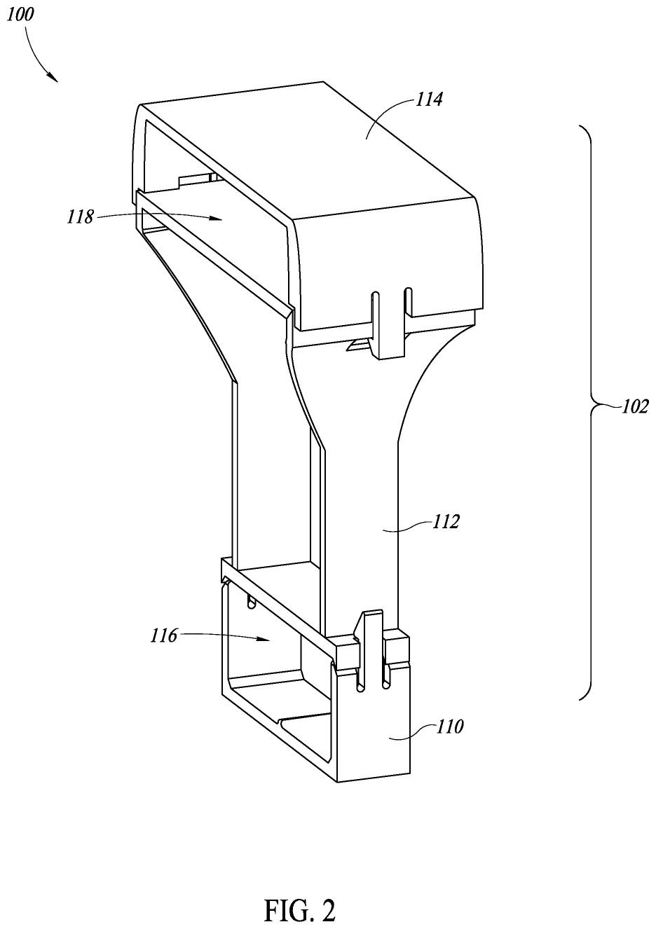

The present disclosure is generally directed to devices, systems, and methods for obtaining accurate temperature measurements using a thermographic camera and a passive reference object. FIG. 1 illustrates a perspective view of a system 100 with a case 102 housing a thermographic camera 104 and a reference object 106. FIG. 2 is a perspective view of the system 100 without the thermographic camera 104 and reference object 106 to provide more detail of the case 102.

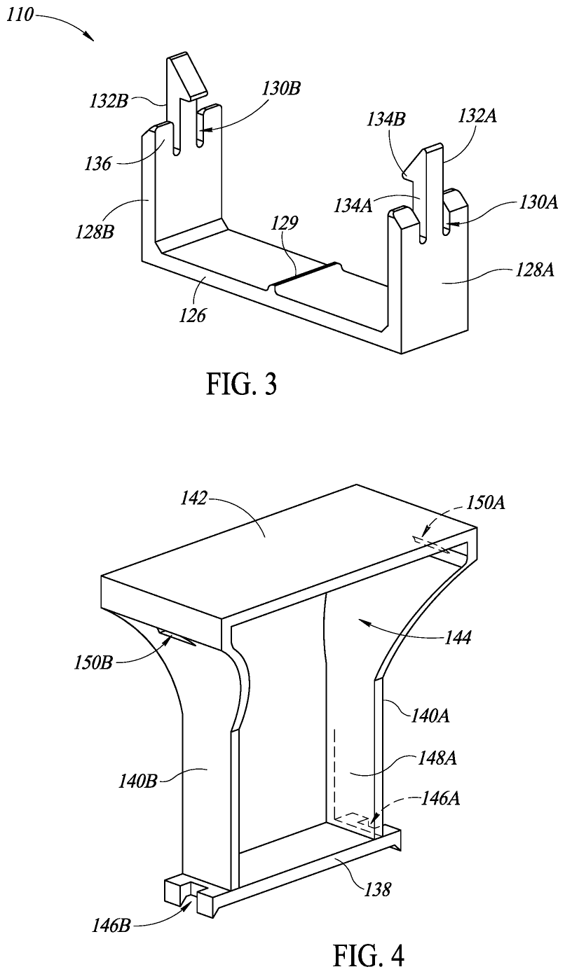

With reference to FIG. 1 and FIG. 2, the system 100 includes the case 102 with the thermographic camera 104 and the reference object 106 received in the case 102. The case 102 may also be referred to herein as a housing 102 or a body 102. The thermographic camera 104 has a line of sight 108 with the case 102 positioning at least a portion of the reference object 106 in the line of sight 108 of the camera 104, as shown in FIG. 1. More specifically, the case 102 includes a base 110, an extension element 112, and a cover 114. The base 110 is coupled to the extension element 112 and the extension element 112 is coupled to the cover 114. The case 102 includes a first opening 116 (FIG. 2) between the base 110 and the extension element 112 and a second opening 118 between the extension element 112 and the cover 114, as shown in FIG. 2. The thermographic camera 104 is received in the first opening 116 and the reference object 106 is received in the second opening 118. The base 110, the extension element 112 and the cover 114 will be described in more detail herein with reference to FIGS. 3-5.

A position of the reference object 106 with respect to the second opening 118 may be adjustable, in some embodiments. In other words, an amount or portion of the reference object 106 in the line of sight 108 of the camera 104 can be selected by the operator of the system 100. In one or more embodiments, the line of sight 108 defines an area 120 proximate the reference object 106, and the reference object 106 occupies approximately 10% of the area 120 of the line of sight 108 proximate the reference object 106. In some embodiments, the reference object 106 occupies more or less than 10% of the area 120, such as 1%, 2%, 3%, 4%, 5%, 6%, 7%, 8%, 9%, 11%, 12%, 13%, 14%, 15%, 20%, 25%, 30%, 50%, or more or less. It is to be appreciated that the above percentages may also be expressed as a range that includes all amounts between the whole number integer percentages. By way of non-limiting example, the reference object 106 may occupy 10%-15% of the area 120, which includes 10.125% or 10.5% of the area 120, among others.

Further, the reference object 106 is thermally inert, in some embodiments, meaning that it is formed of a material with high specific heat that is slow to react to temperature changes. In some embodiments, the reference object 106 has an overall size and shape that is minimized to the extent possible, but is formed of a material with a high mass and density, although the same is not necessarily required. By way of non-limiting example, the reference object 106 may be comprised of materials such as wood (either natural or engineered, any variety or species), cork, rubber, leather, paper or cardboard, phenolic cast resins, molding compounds (such as phenol-formaldehyde molding compounds, polytetrafluoroethylene molding compound, and others), polycarbonates, polyethylene terephthalate, polyimides, polyisoprene natural rubber, polyisoprene hard rubber, polymethylmethacrylate, polypropylene, polystyrene, polytetrafluoroethylene (PTFE), polyurethanes, polyvinylchloride (PVC), and other like materials with similar specific heat capacity, mass, and density. In one non-limiting example, the reference object 106 is not invariable or held at any particular temperature, but rather has a temperature that remains relatively constant (e.g., within 0.2 or 0.3 degrees Celsius) over a time period of 10-20 minutes. The temperature of the reference object 106 may change during the course of use based on environmental factors. However, such changes are acceptable for the system 100 because the system 100 relies on the reference object 106 as a relatively constant reference over a short period of time.

Further, the reference object 106 has surfaces 122A, 122B that are in the line of sight 108 of the camera 104 that have a high emissivity and a low reflectivity. The surface 122A is a bottom surface of the reference object 106 facing the camera 104 and the surface 122B is a side surface of the reference object 106 in the line of sight 108 of the camera and perpendicular to the surface 122A, in one or more embodiments. The above materials of the reference object 106 may also have a high emissivity and a low reflectivity, such that an additional coating is not needed on the surfaces 122A, 122B. For example, polypropylene has emissivity and reflectivity properties that may be suitable for use without a further coating on the surfaces 122A, 122B. However, in some embodiments, the surfaces 122A, 122B include an additional coating to increase emissivity and reduce reflectivity. For example, the surfaces 122A, 122B may be coated with electric tape, vinyl, or fiberglass cloth, among other similar materials, to improve emissivity and reduce reflectivity of the surfaces 122A, 122B in the line of sight 108 of the camera 104.

In some embodiments, only the surfaces 122A, 122B of the reference object 106 have the additional coating while in one or more embodiments, only surface 122A or only surface 122B has the coating. In yet further embodiments, every surface of the reference object 106 is coated. Still further, in one or more embodiments, only or both of the surfaces 122A, 122B may have the emissivity coating and the remaining surfaces of the reference object 106 may coated with a high reflectivity material, such as aluminum foil, mylar, mirrors, or other like materials to further isolate the reference object 106 and slow down the effects of the environment on the temperature of the reference object 106. As such, the operator can select the type of material for the coating or covering one each surface of the reference object 106 and its location to improve accuracy of the temperature measurements of the camera 104.

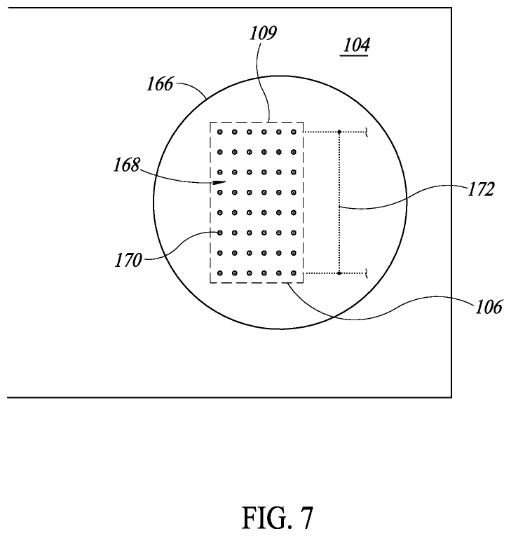

The reference object 106 is positioned by the case 102 a distance 124 from the camera 104. In some embodiments, the distance 124 is any value between 1 and 10 centimeters (cm). In one or more embodiments, the distance is more or less than 1-10 cm. In the illustrated embodiment, the distance 124 is equal to 5 cm or approximately 5 cm (between 4.5 cm and 5.5 cm). It is has been determined that the distance being 5 cm is a compromise between competing goals with respect to improving accuracy of the camera 104. On one hand, decreasing the distance 124 creates a more compact device that is less susceptible to damage. However, on the other hand, decreasing the distance 124 also increases noise (e.g., thermal noise) due to interference from the camera 104. Therefore, the distance 124 is also selected to reduce excessive noise. In some embodiments, the distance 124 of 5 cm or approximately 5 cm is a compromise that balances these competing interests, in one non-limiting example. The distance 124 of 5 cm corresponds to approximately 10% (between 8% and 12%) of the area 120 of the line of sight 108 of the camera 104 at the location of the reference object 106. In other words, the reference object is visible to approximately 10% of the sensors of the camera 104, as explained below with reference to FIG. 7. Further, reference object 106 is passive, in some embodiments, meaning that it does not utilize or rely on any outside power source or other systems for its operation.

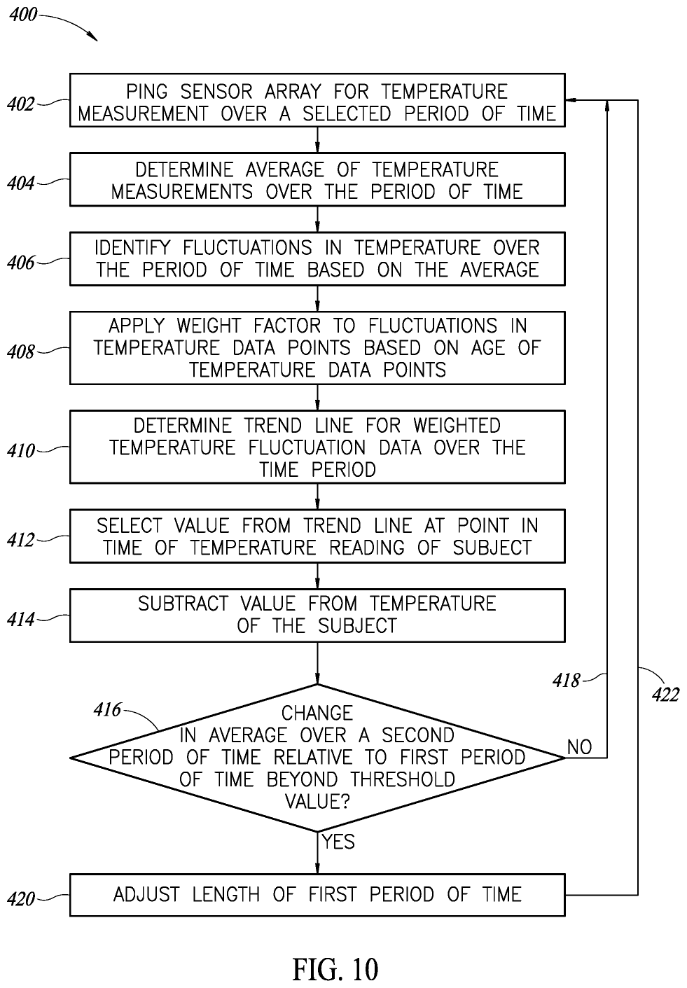

In some embodiments, the reference object 106 is supplemented with a temperature measurement device, such as a thermometer disposed near or on, embedded, or built into the reference object 106. The thermometer is connected to the system 100 through a wired or wireless connection, such as a USB connection in one non-limiting example, to provide direct and accurate feedback about the temperature of the reference object 106 to eliminate the need for computational adjustment, as described below with reference to FIG. 10. The supplemental thermometer may be useful to reduce the complexity of the software associated with the system 100 while improving accuracy, and may be well suited for use of the system 100 in environments with high frequency and amplitude of environmental changes. In one non-limiting example, the system 100 may include the supplemental thermometer may be useful where the system 100 is positioned near a door where frequent changes in temperature occur when the door is opened or closed, such as when the temperature outside is high (e.g., 30 degrees C. or more) and the temperature inside proximate the system is low (e.g., 15 to 20 degrees C.). The same is true for when the system 100 is positioned near a door between two rooms, one of which is temperature controlled or cooled and one of which is not or is heated.

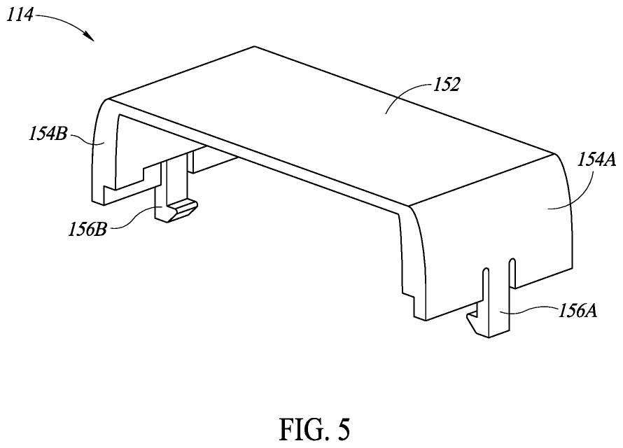

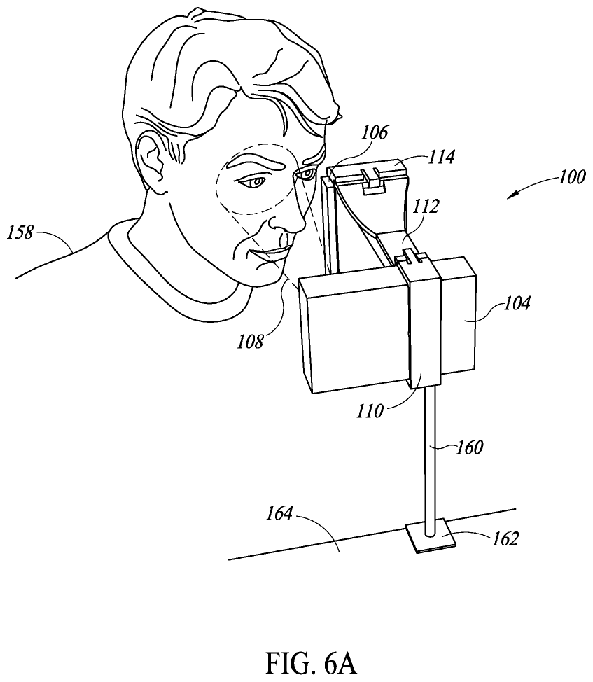

FIGS. 3-5 illustrate additional detail of component parts of the system 100. Specifically, FIG. 3 is a perspective view of the base 110, FIG. 4 is a perspective view of the extension element 112 and FIG. 5 is a perspective view of the cover 114 of the case 102 in FIG. 1 and FIG. 2.

Beginning with FIG. 3, the base 110 includes a base plate 126 and a pair of flanges 128A, 128B extending from the base plate 126. In some embodiments, the flanges 128A, 128B extend from the base plate 126 perpendicular to the base plate 126, although the flanges 128A, 128B may also be at any angle to the base plate 126. The pair of flanges 128A, 128B are spaced from each other across a width of the base plate 126 and are positioned at an outer peripheral edge of the base plate 126 in the illustrated embodiment. However, the flanges 128A, 128B can be positioned anywhere along base plate 126 in some embodiments and may be spaced from the outer peripheral edge of the base plate 126. The space between the flanges 128A, 128B provides the width of the first opening 116, as shown in FIG. 2. In other words, the flanges 128A, 128B define side boundaries of the first opening 116 (FIG. 2). The base plate 126 provides a bottom boundary for the first opening 116. As such, the arrangement and position of the base plate 126 and flanges 128A, 128B can be selected according to the size of the first opening 116 (FIG. 2).

The base plate 126 further includes a ridge 129, in some embodiments, extending from a center of the base plate 126 between the flanges 128A, 128B. The ridge 129 may be used in coupling the thermographic camera 104 to the case 102 (FIG. 1). For example, the thermographic camera (FIG. 1) may have a channel with a size and a shape to receive the ridge 129, such that the ridge 129 assists with holding the camera 104 (FIG. 1) in place when the camera 104 (FIG. 1) is coupled to the case 102 (FIG. 1). Each of the flanges 128A, 128B further includes a respective channel 130A, 130B and a first connector 132A, 132B extending from the channel 130A, 130B of the corresponding flange 128A, 128B. Each of the first connectors 132A, 132B are spaced from sidewalls of corresponding ones of the channels 130A, 130B. Further, each of the first connectors 132A, 132B include an extension portion 134A and a connection portion 134B. The extension portion 134A is aligned with, or coplanar with, respective ones of the flanges 128A, 128B. The connection portion 134B extends perpendicularly to the extension portion 134A toward the center of the base plate 126. In other words, the connection portion 134B extends away from the extension portion 134A and toward an opposite one of the flanges 128A, 128B. The base 110 further includes protrusions 136 on either side of each extension portion 134A that define boundaries of the channels 130A, 130B.

Turning to FIG. 4, the extension element 112 includes a first plate 138, a pair of supports 140A, 140B, and a second plate 142. The pair of supports 140A, 140B are coupled to each of the first and second plates 138, 142, as shown in FIG. 4. Further, the pair of supports 140A, 140B are spaced from each other across a width of each of the first and second plates 138, 142. The supports 140A, 140B are positioned at an outer peripheral edge of the second plate 142, but are spaced from an outer peripheral edge of the first plate 138, as shown in FIG. 4. The first plate 138 is spaced from the second plate 142 across a height of the supports 140A, 140B, such that the plates 138, 142 and supports 140A, 140B define an opening 144. Further, the first plate 138 of the extension element 112 defines an outer boundary of the first opening 116 (FIG. 2), along with the base plate 126 and flanges 128A, 128B of the base 110 (FIG. 3).

The first plate 138 of the extension element 112 further includes a first aperture 146A and a second aperture 146B extending through the first plate 138 proximate the supports 140A, 140B. More specifically, the apertures 146A, 146B are positioned proximate the interface between the first plate 138 and the supports 140A, 140B and are positioned toward an outer peripheral edge of the first plate 138 from the supports 140A, 140B. As such, from right to left, the first plate includes the aperture 146A, the interface between plate 138 and support 140A, the interface between support 140B and the aperture 146B. The apertures 146A, 146B are positioned to correspond to first connectors 132A, 132B of the base 110 (FIG. 3). More specifically, FIG. 2 shows that the first connectors 132A, 132B of the base 110 are received in the apertures 146A, 146B of the first plate 138 of the extension element 112 to couple the base 110 to the extension element 112. The connectors 132A, 132B are received with the connection portion 134B of each connector 132A, 132B in contact with the first plate 138.

As such, the connectors 132A, 132B are snap connectors that are inserted by pushing the connection portion 134B through a corresponding aperture 146A, 146B and past first plate 138 until the connection portion 134B is in contact with the first plate 138. The extension portion 134A holds the connection portion 134B of each connector 132A, 132B in place via elastic force. The operator can remove the connectors 132A, 132B from the apertures 146A, 146B by applying a force to manipulate the connection portion 134B away from the first plate 138. The apertures 146A, 146B are therefore structured to removably receive and temporarily secure the connectors 132A, 132B of the base 110.

The supports 140A, 140B of the extension element 112 have a straight, linear portion 148A that extends perpendicular to the first plate 138, in some embodiments, as well as a curved portion 148B, such that the width of the opening 144 through the extension element 112 changes along a height of the opening 144. In other words, a first width between the supports 140A, 140B at the linear portion 148A is less than a second width between the supports 140A, 140B at the curved portion 148B, in some embodiments. The first and second widths may be equal or the second width may be less than the first width in one or more embodiments. Further, the first width may remain constant at the linear portions 148A before changing continuously at the curved portions 148B of the supports 140A, 140B. The change in width provides for a compact design that facilities connection between the components. In other words, the narrower width near the first plate 138 allows for a convenient and easy to use connection between the apertures 146A, 146B and the connectors 132A, 132B of the base 110 (FIG. 3).

Moreover, the change in width between the supports 140A, 140B accommodates the camera 104 and the reference object 106 (FIG. 1), which may have different sizes and shapes, in some embodiments. Put another way, the line of sight 108 of the camera 104 expands as it moves away from the camera 104 (FIG. 1). Because the reference object 106 is spaced from the camera 104, the reference object 106 may be selected to have a width that is greater than the camera 104 such that the reference object 106 occupies all of a selected portion of the line of sight 108 of the camera 104 (FIG. 1 and corresponding description). Thus, a width of the reference object 106 may be greater than a width of the camera 104. As such, the shape of the extension element 112 and the widths between the supports 140A, 140B allows for optimal positioning of the reference object 106 in order to improve accuracy of the temperature readings by the system 100 (FIG. 1).

The extension element 112 further includes a third aperture 150A and a fourth aperture 150B. The apertures 150A, 150B extend through respective ones of the supports 140A, 140B proximate an interface between the supports 140A, 140B and the second plate 142. In some embodiments, the apertures 150A, 150B are adjacent to the interface between the supports 140A, 140B. The apertures 150A, 150B may be holes through the supports 140A, 140B, while the apertures 146A, 146B are similar to channels, with open side, as shown in FIG. 4. As described further below, the apertures 150A, 150B are structured to receive connectors of the cover 114 to couple the cover 114 to the extension element 112.

With reference to FIG. 5, the cover 114 includes a plate 152 and a pair of flanges 154A, 154B coupled to and extending from the plate 152. The flanges 154A, 154B are spaced from each other across a width of the plate 152 and are positioned at an outer peripheral edge of the plate 152, in some embodiments. Each of the flanges 154A, 154B further includes a second connector 156A, 156B extending from the corresponding flange 154A, 154B. The connectors 156A, 156B may be the same as the first connectors 132A, 132B described with reference to FIG. 3. As such, repetitive description has been omitted. The second connectors 156A, 156B are sized and shaped to be received in the apertures 150A, 150B of the extension element 112 in a similar manner as described with respect to connectors 132A, 132B and apertures 146A, 146B (FIG. 3 and FIG. 4) to couple the cover 114 to the extension element 112. The cover 114 and the second plate 142 of the extension element 112 (FIG. 4) define boundaries of the second opening 118 (FIG. 2). In other words, the cover 114 and the second plate 142 of the extension element 112 assist with coupling the reference object 106 to the case 102 (FIG. 1). The size and shape of the cover 114 can be selected according to a size and a shape of the reference object 106 (FIG. 1), such that the dimensions of the cover 114 can vary, in some embodiments.

In some embodiments, each of the components described above for system 100, including the thermographic the case 102, the thermographic camera 104, and the reference object 106 are integrated into a single system with each component permanently affixed to other components. In other words, in one or more embodiments, none of the component parts of the system 100 are removable or adjustable. As such, the reference object 106 may be fixed in place with a portion of the reference object 106 in the line of sight 108 of the camera 104 at the fixed distance 124 from the camera 104, which itself is permanently coupled to the case 102, in one non-limiting example. In some embodiments, the case 102 and the reference object 106 are fixedly attached to each other, and the base 110 and the extension element 112 are configured to removably receive one or more different types of thermographic cameras 104. In general, the thermographic camera 104 may be any commercially available thermographic camera 104 and need not be described further.

Still further, each of the component parts of the system 100 described herein may be removable or adjustable. In one non-limiting example, the case 102 includes the base 110 and the cover 114 removably coupled to the extension element 112. A portion of the case 102, such as opening 116 defined by base 110 and extension element 112, is configured to receive one or more different thermographic cameras 104. Further, the position of the camera 104 relative to case 102 may be adjustable by removing the base 110, adjusting the camera 104 and re-attaching the base 110. The same is true for the reference object 106, namely that the reference object 106 may be removable and adjustable relative to case 102, in some embodiments.

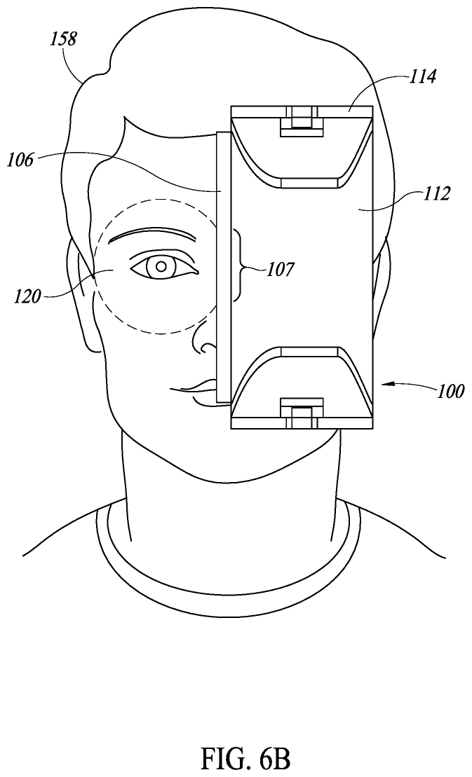

FIG. 6A and FIG. 6B represent a use configuration of the system 100.

Specifically, FIG. 6A is a perspective view of the system 100 reading a temperature of a subject 158. FIG. 6B is an elevational view of the subject 158 from the point of view of the thermographic camera 104. In operation, the system 100 may be coupled to a support rod 160, which is turned coupled to a bracket 162 that is mounted to a table 164. In some embodiments, the system 100 is coupled to other like supports, such as on wall or on a plastic or glass shield. The system 100 is oriented towards the subject 158, or in other words, the line of sight 108 of the camera 104 is directed towards the subject 158, as shown in FIG. 6A. The reference object 106 is in the line of sight 108 of the camera 104 and positioned between the camera 104 and the subject 158. Further, the reference object 106 is spaced from the subject 158.

While the thermographic camera 104 can be used to scan any portion of the subject, in some embodiments, the thermographic camera 104 is intended for use with areas of the subject that are most likely to give accurate temperature readings. One such area, among others, is the area around the eye of the subject 158. In particular, the area to be scanned by the camera 104 is the area immediately surrounding the eye of the subject 158, which may be also be referred to as an inner eye, eye socket, or eye orbit of the subject 158, in one or more embodiments. Although FIG. 6A and FIG. 6B illustrate the line of sight 108 aligned with a larger area of the subject 158 proximate the eye of the subject 158, in reality, the area corresponding to the line of sight 108 of the camera 104 may be smaller and may be limited to the area immediately adjacent the eye of the subject 158. The area of the line of sight 108 of the camera 104 on the subject 158 can be selected based on a size of the sensor array of the camera 104 and the position of the system 100 relative to the subject 158. Further, although the subject 158 is illustrated herein as a human being, other subjects are contemplated herein, as the camera 104 can be used to scan any object.

FIG. 6B illustrates the position and size of the portion of the reference object 106 in the line of sight 108 of the camera 104 relative to the subject 158. FIG. 6B is an elevational view of the subject 158 from the point of view of the sensor array of the camera 104. As shown in FIG. 6B, the orientation of the camera 104 results in the area 120 corresponding to the line of sight 108 of the camera 104 being located on a selected area of the subject 158 that is to be scanned for temperature. A portion 107 of the reference object 106 is located in the area 120 that corresponds to the line of sight 108. As stated above, the portion 107 corresponds to a selected percentage of the scan area 120 of the camera 104. In some embodiments, the portion 107 occupies between 5 and 10% of the area 120, which is equal to or approximately equal (e.g. within 10% of being equal) to the area of the eye of the subject 158. In other words, in one or more embodiments, the portion 107 of the reference object 106 that is selected to be placed in the scan area 120 of the camera 102 is based on a size of the area to be scanned. In FIG. 6B, the portion 107 is approximately equal in size to the area immediately surrounding the eye of the subject 158. It has been determined that this relationship to the size of the portion 107 in the area 120 relative to the subject 158 produces the most accurate results and allows for more efficient calculations by the system 100, although other sizes, positions, and percentages of the portion 107 of the reference object 106 in the area 120 are contemplated herein. In one non-limiting example, having the portion 107 of the reference object 106 approximate the area to be measured of the subject 158 allows the system 100 to compare the temperature of two areas with like sizes, such that no additional calculations are utilized to account for difference in area or variation in temperature over area. In some embodiments where the subject 158 is instructed to position themselves at a different distance from the system 100, then the size of the portion 107 in the area 120 may be adjusted accordingly.

FIG. 7 is a top plan view of a portion of the thermographic camera 104 containing an aperture 166 of the camera 104. A sensor array 168 is located in the aperture 166. The sensor array 168 includes a plurality of sensors 170 (e.g., infrared photodetectors) arranged in a selected number of rows and columns. The dotted lines 172 represent a continuation of the sensors 170 in the array 168, as the array 168 may contain more sensors 170 than are clearly able to be displayed in FIG. 7. The array 168 can contain any number of sensors 170 in any arrangement. For example, the array 168 may contain tens, hundreds, thousands, or more sensors 170 arranged in any suitable number of rows and columns. In one non-limiting example, the sensor array 168 includes 120 rows and 160 columns or 160 rows and 120 columns of sensors 170. FIG. 7 specifically illustrates a portion of the sensor array 168 corresponding to the portion 107 (FIG. 6B) of the reference object 106 in the line of sight 108 (FIG. 1) of the camera 104, represented in FIG. 7 by dashed lines 109. In other words, the dashed lines 109 correspond to an area of the sensor array 168 aligned with the reference object 106 (FIG. 1).

In some embodiments, the portion 109 of the sensor array 168 contains 48 sensors 170 arranged in 8 rows and 6 columns. The 48 sensors 170 could also be arranged in 6 rows and 8 columns, in some embodiments. Further, the portion 109 may include or more less than 48 sensors 170 based on the position of the reference object 106, as described herein. In some non-limiting examples, the portion 109 may contain 10, 20, 30, 40, 50, 60, 70, 80, 90, 100 or more or less sensors 170. As such, the number of sensors 170 in the portion 109 can be selected to vary the accuracy and readings of the camera 104. The thermographic camera 104 creates images using detected infrared radiation from the sensor array 168. In some embodiments, the thermographic camera 104 is sensitive to wavelengths of light from about 1,000 nanometers (“nm”) to about 14,000 nm. The thermographic camera 104 can be a commercially available camera and certain features will not be described further.

The selection of the size of the portion 109 and the number of sensors 170 that correspond to the portion 109 is based on the amount of influence that neighboring activity has on the sensors 170 in the portion 109. In other words, 48 sensors 170 have been selected in one non-limiting example because this number of sensors corresponds to a an area of the array 168 that is appropriate for reading the reference object 106 while reducing bleeding of temperature measurements based on noise from radiation around the portion 109 of the reference object 106 that is detected by the sensors 170 in the portion 109. The number of the sensors 170 is also selected based on the feasibility of manufacturing and installation of the system 100. The selected number of 48 sensors 170 in this non-limiting example has been determined to be one of many potential solutions for balancing these interests.

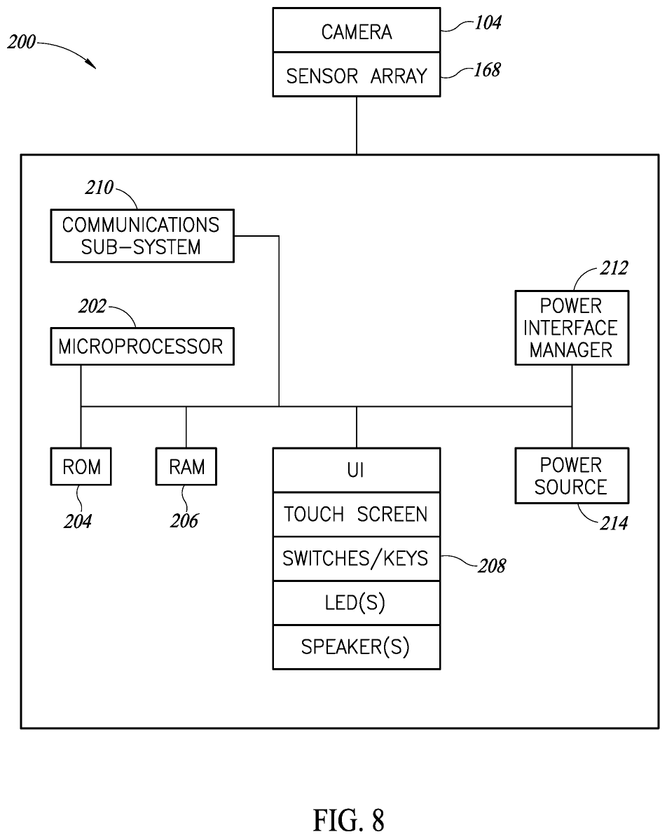

Further, the camera 104 includes, or is associated with a control system 200 indicated schematically in FIG. 8. The control system 200 may be internal to the thermographic camera 104, or may be part of an external system in electronic communication with the camera 104, such as a computer, mobile device, tablet, or other system through a wired or wireless connection using any of the below communications protocols.

In particular, the control system 200 is generally operable to provide power to the system 100 and the camera 104 and to process, transmit, and store thermal imaging data received from the camera 104 and the sensor array 168, in some embodiments. FIG. 8 schematically illustrates various control systems, modules, or other sub-systems that operate to control the system 100, including the exchange of data between the imaging camera 104, sensor array 168, and the control system 200.

The control system 200 includes a controller 202, for example a microprocessor, digital signal processor, programmable gate array (PGA) or application specific integrated circuit (ASIC). The control system 200 includes one or more non-transitory storage mediums, for example read only memory (ROM) 204, random access memory (RAM) 206, Flash memory (not shown), or other physical computer- or processor-readable storage media. The non-transitory storage mediums may store instructions and/or data used by the controller 202, for example an operating system (OS) and/or applications. The instructions as executed by the controller 202 may execute logic to perform the functionality of the various embodiments of the system 100 described herein, including, but not limited to, capturing and processing thermal image data from the camera 104 and the sensor array 168.

The control system 200 may include, or may be communicatively coupled to, a user interface 208, to allow an end user to operate or otherwise provide input to the system 100 regarding the operational state or condition of the system 100. The user interface 208 may include a number of user actuatable controls accessible from the system 100 and camera 104, or from an external device. For example, the user interface 208 may include a number of switches or keys operable to turn the system 100 ON and OFF and/or to set various operating parameters of the system 100.

Additionally, or alternatively, the user interface 208 may include a display, for instance a touch panel display. The touch panel display (e.g., liquid crystal display, light emitting diode display, organic light emitting diode display, or other like displays, with a touch sensitive overlay) may provide both an input and an output interface for the end user. The touch panel display may present a graphical user interface, with various user selectable icons, menus, check boxes, dialog boxes, and other components and elements selectable by the end user to set operational states or conditions of the system 100. The user interface 208 may also include one or more auditory transducers, for example one or more speakers and/or microphones. Such may allow audible alert notifications or signals to be provided to an end user, such as a signal corresponding to a certain temperature reading. In other words, the system 100 may be used to determine whether the temperature of the subject 158 (FIG. 6A) is within a selected range, such as between 36 degrees Celsius and 38 degrees Celsius. If so, then the control system 200 may execute instructions to produce an audible alert notification to an operator indicating that the temperature of the subject 158 (FIG. 6A) is within the selected range. Such may additionally, or alternatively, allow an end user to provide audible commands or instructions. The user interface 208 may include additional components and/or different components than those illustrated or described, and/or may omit some components, in one or more embodiments.

In some embodiments, the user interface 208 may further include lights, which may be light emitting diodes (LEDs) or other like devices, to provide a visual indicator to an operator regarding the temperature reading of the subject 158 (FIG. 6A). For example, if the temperature of the subject 158 (FIG. 6A) is in the selected range above, then the control system 200 may execute instructions to provide a first color of light to the operator via the LEDs, such as green. If the temperature of the subject 158 (FIG. 6A) is outside of the selected range, then the control system 200 may execute instructions to provide a second, different color of light to the operator via the LEDs, such as red.

The switches and keys or the graphical user interface may, for example, include toggle switches, a keypad or keyboard, rocker switches, trackball, joystick or thumbstick, in some embodiments. The switches and keys or the graphical user interface may, for example, allow an end user to turn ON the system 100, start or end a thermal imaging mode, communicably couple or decouple to remote accessories and programs, access, transmit, or process thermal imaging data, activate or deactivate audio subsystems, and other like commands.

The control system 200 includes a communications sub-system 210 that may include one or more communications modules or components which facilitate communications with the camera 104 and the sensor array 168 or various components of one or more external devices, such as a personal computer, mobile device, table, processor, or other like devices. The communications sub-system 210 may provide wireless or wired communications to the one or more external devices. The communications sub-system 210 may include wireless receivers, wireless transmitters, wireless transceivers, or other like devices to provide wireless signal paths to the various remote components or systems of the one or more paired devices. The communications sub-system 210 may, for example, include components enabling short range (e.g., via Bluetooth®, near field communication (NFC), or radio frequency identification (RFID) components and protocols) or longer range wireless communications (e.g., over a wireless LAN, Low-Power-Wide-Area Network (LPWAN), satellite, or cellular network) and may include one or more modems or one or more Ethernet or other types of communications cards or components for doing so. The communications sub-system 210 may include one or more bridges or routers suitable to handle network traffic including switched packet type communications protocols (TCP/IP), Ethernet or other networking protocols. In some embodiments, the wired or wireless communications with the external device may provide access to look-up tables indicative of various material properties and light wavelength properties. In one non-limiting example, the look-up tables may include information regarding the properties of the reference object (106), such as emissivity, reflectivity, density, mass, and other like properties described herein.

The control system 200 includes a power interface manager 212 that manages supply of power from a power source 214 to the various components of the control system 200, for example, the controller 202 integrated in the system 200, or attached to the system 100. The power interface manager 212 is coupled to the controller 202 and the power source 214. Alternatively, in some embodiments, the power interface manager 212 can be integrated in the controller 202. The power source 214 may include an external power supply, batteries, or other like devices. The power interface manager 212 may include power converters, rectifiers, buses, gates, circuitry, and other like devices. In particular, the power interface manager 212 can control, limit, and restrict the supply of power from the power source 214 based on the various operational states of the system 100 in association with execution of instructions stored in the control system 200 corresponding to the various operational states.

In some embodiments, the instructions and/or data stored on the non-transitory storage mediums that may be used by the controller 202, such as, for example, ROM 204, RAM 206 and Flash memory (not shown), includes or provides an application program interface (“API”) that provides programmatic access to one or more functions of the control system 200. For example, such an API may provide a programmatic interface to control one or more operational characteristics of the system 100, including, but not limited to, one or more functions of the user interface 208, or processing the thermal imaging data received from the camera 104 or sensor array 168. Such control may be invoked by one of the other programs, other remote device or system (not shown), or some other module. In this manner, the API may facilitate the development of third-party software, such as various different user interfaces and control systems for other devices, plug-ins, and adapters, and the like to facilitate interactivity and customization of the operation and devices within the system 100.

In one non-limiting example embodiment, components or modules of the control system 200 and other devices within the system 100 are implemented using standard programming techniques. For example, the logic to perform the functionality of the various embodiments described herein may be implemented as a “native” executable running on the controller, e.g., microprocessor 202, along with one or more static or dynamic libraries. In one or more embodiments, various functions of the control system 200 may be implemented as instructions processed by a virtual machine that executes as one or more programs whose instructions are stored on ROM 204 and/or RAM 206. In general, a range of known programming languages may be employed for implementing such example embodiments, including representative embodiments of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VB Script, and the like), or declarative (e.g., SQL, Prolog, and the like), among others.

In a software or firmware embodiment, instructions stored in a memory configure, when executed, one or more processors of the control system 200, such as microprocessor 202, to perform the functions of the control system 200. The instructions cause the microprocessor 202 or some other processor, such as an I/O controller/processor, to process and act on information received from one or more sensors 170 of the sensor array 168 or the information from the camera 104 to provide the functionality and operations of measuring a temperature of the subject 158 (FIG. 6A).

The embodiments described above may also use well-known or other synchronous or asynchronous client-server computing techniques. However, the various components may be implemented using more monolithic programming techniques as well, for example, as an executable running on a single microprocessor, or alternatively decomposed using a variety of known structuring techniques, including but not limited to, multiprogramming, multithreading, client-server, or peer-to-peer (e.g., Bluetooth®, NFC or RFID wireless technology, mesh networks, etc., providing a communication channel between the devices within the system 100), running on one or more computer systems each having one or more central processing units (CPUs) or other processors. Some embodiments may execute concurrently and asynchronously, and communicate using message passing techniques. Also, other functions could be implemented and/or performed by each component/module, and in different orders, and by different components/modules, yet still achieve the functions of the control system 200.

In addition, programming interfaces to the data stored on and functionality provided by the control system 200, can be available by standard mechanisms such as through C, C++, C#, and Java APIs; libraries for accessing files, databases, or other data repositories; scripting languages; or Web servers, FTP servers, or other types of servers providing access to stored data. The data stored and utilized by the control system 200 and overall system 100 may be implemented as one or more database systems, file systems, or any other technique for storing such information, or any combination of the above, including embodiments using distributed computing techniques.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, and Web Services (XML-RPC, JAX-RPC, SOAP, and the like). Other variations are possible. Other functionality could also be provided by each component/module, or existing functionality could be distributed amongst the components/modules within the system 100 in different ways, yet still achieve the functions of the control system 100 and camera 104.

Furthermore, in some embodiments, some or all of the components of the control system 200 and components of other devices within the system 100 and camera 104 may be implemented or provided in other manners, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network, cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use, or provide the contents to perform, at least some of the described techniques.

The control system 200 is in electrical communication with the camera 104 and the sensor array 168, either through wires, which may be internally or externally located with respect to the system 100 or wirelessly using the above communications protocols and corresponding hardware and firmware. Further, the control system 200 may be integrated into the system 100, such as in the camera 104, or located external to the system 100. In an embodiment, the control system 200 provides power to the system 100 and camera 104 and also receives thermal imaging data from the camera 104 and the sensor array 168. The control system 200 can include at least one processor such as in a standard computer, for processing the thermal imaging data, or alternatively the control system 200 can transmit the imaging data to an additional external processor or computer that is not specifically illustrated for clarity. Further, the control system 200 may include instructions stored in the ROM 204 and/or the RAM 206 or some other memory, that when executed by the microprocessor, cause the system 100 and camera 104 to perform certain functionality, as described herein. Further, the control system 200 may include instructions for identifying fluctuations in temperature data received from the camera 104 and sensor array 168 and corrected a temperature measurement of a subject 158 (FIG. 6A) based on the identified fluctuations, as described herein.

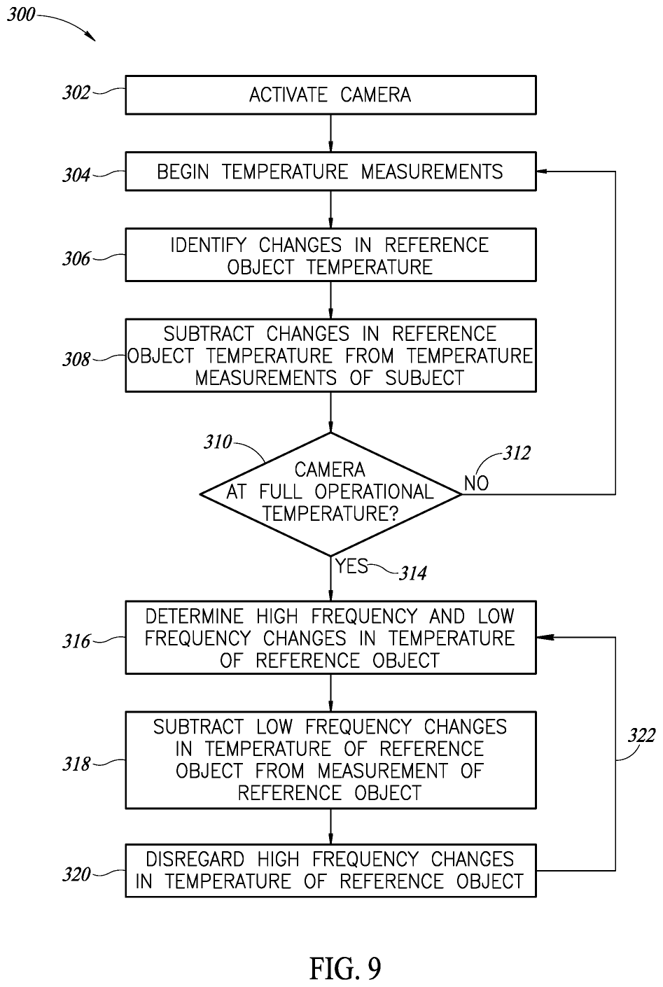

FIG. 9 illustrates one or more embodiments of a method 300 for a start-up procedure and an operating state of the system 100 according to the present disclosure. In other words, FIG. 9 and the corresponding description demonstrate non-limiting examples of activation and use of the system 100 described herein. Except as otherwise indicated, each of the below functions may be executed by the processor 202 based on instructions stored in the ROM 204, RAM 206, or other memory of the control system 200 described with reference to FIG. 8.

With reference to FIG. 9 and with continuing reference to FIGS. 1-7, the method 300 begins at 302 by activating the thermographic camera 104 (FIG. 1). Activation of the camera 104 can be accomplished through a power switch, toggle, or button on the camera 104 itself, or through an external system containing control system 200 and user interface 208. More specifically, when the control system 200 receives an activation signal, the processor 202 executes instructions that cause the power interface manager 212 to distribute power from the power supply 214 to the camera 104. After activation, there is a warm-period in which the control system 200 does not initiate any temperature measurements by the camera 104. More specifically, during the warm-up period, the rate of change of temperature of the camera 104 is too high to produce accurate temperature measurements, in some embodiments. As such, the method 300 includes an initial warm-up period after activation of the camera 104 at 302 to allow for initial warming of the camera 104 until the rate of change of temperature of the camera 104 decreases to an appropriate level. In some embodiments, the warm-up period is 5 minutes or about 5 minutes (e.g., between 4.5 and 5.5 minutes). However, the warm-up period may be selected to be more or less than 5 minutes in one or more embodiments.

After the warm-up period, the system 100 enters an intermediate period whereby the camera 104 is still heating to a full operational temperature, but the rate of temperature change of the camera 104 is less than during the warm-up time period. The intermediate time period may begin immediately after the warm-up period (e.g., after 5 minutes of operation) and continue until the camera has been operational for 60 minutes or about 60 minutes (e.g., between 55 minutes and 65 minutes), or more or less in some embodiments. In other words, the intermediate period is between 5 minutes and 1 hour from activation of the camera at 302, in one non-limiting example. After 1 hour from activation of the camera at 302, the camera can be considered to be at the full operational temperature, in some embodiments.

The rate of change of temperature of the camera during the intermediate period is sufficiently low that the method 300 continues at 304 by initiating temperature measurements via the camera 104 and the sensor array 168 (FIG. 7). The method 300 includes the camera producing temperature measurement data on a continuous basis (e.g., after activation at 302, the camera 104 continuously provides temperature measurement data until deactivated) as well as on a point in time or as instructed basis (e.g., after activation at 302, the camera 104 provides temperature measurement data only upon instructions to do so from an operator through control system 200 or upon receipt and processing of a temperature measurement signal, such as when the subject 158 is proximate the system 100).

The method 300 continues at 306 by observing and identifying changes in the reference object 106 temperature data. In other words, the system 100 identifies temperature data associated with the reference object 106 and identifies fluctuations in the temperature of the reference object 106. During the intermediate period, the dominant source of the fluctuations in the temperature of the reference object 106 is due to the change in temperature of the camera 104 as the camera 104 continues warming up to the full operational temperature. The change in temperature from the camera 104 can result in detected large fluctuations in temperature of the reference object 106 at a high frequency, such as multiple changes in temperature of 0.8 or 0.9 degrees Celsius over a course of a minute in one non-limiting example. Because the reference object 106 is inert and has a high specific heat, as described herein, the reference object 106 should not experience similar fluctuations. In other words, using the reference object 106 as a base line enables the system 100 to determine that the fluctuations in temperature during the intermediate period are largely attributable to sensor drift based on warming of the camera 104 because the reference object 106 does not experience significant changes in temperature over a short period of time due to its material composition.

As such, the identified fluctuations are interpreted by the system 100 and control system 200 as sensor drift attributable to the change in temperature of the camera 104. Once the temperature fluctuations are identified, the amount of the fluctuation is subtracted from the temperature measurement of the subject 158 (FIG. 6A) at 308. In one non-limiting example, the system 100 may determine that an average or exponential moving average of the fluctuations in temperature of the reference object 106, as described below, is 0.8 degrees Celsius (C). As such, when the subject 158 (FIG. 6A) is measured for temperature at a point in time, the system subtracts 0.8 degrees C. from the temperature of the subject 158 at 308 based on the identified fluctuation to remove the error in the temperature reading of the subject 158 at the first point in time due to sensor drift. Further, in some embodiments, the entire identified fluctuation is subtracted from the temperature measurement of the subject 158 in raw form. In some embodiments, the identified temperature fluctuations are not subtracted in raw form, but rather, an attenuation factor is applied to the raw temperature fluctuation and a modified temperature value is subtracted from the temperature of the subject 158. The subject 158 and the reference object 106 have different base line temperatures, namely, the reference object 106 is cooler on average than the subject 158 where the subject 158 is a human being. Thus, the detected fluctuations may have different amplitudes for the subject 158 and the reference object 158, such that the attenuation factor is applied to accurately reflect the change in temperature of the subject 158 based on the detected fluctuations in the reference object 106. The attenuation factor is determined by the relationship between the base line temperature level between the subject 158 and the reference object 106 or the difference in the temperature of the subject 158 and the reference object 106. In general, the larger the variation between the subject 158 and the reference object 106, the larger the applied attenuation factor. The attenuation factor information is stored in the system 100 and executed based on the detected temperatures of the subject 158 and reference object 106.

Further, the system 100 may identify at 306 and subtract at 308 changes in temperature that are attributable to a change in the environment, despite changes in the environment being less of a source of error during the intermediate period. More specifically, the system 100 and control system 200 obtain temperature data of the reference object 106 over a period of time such as one minute or more or less at 304. The temperature data of the reference object 106 over a plurality of periods of time of the selected length is stored in the system and the system 100 determines, based on historical time periods, whether there has been a change in the average temperature of the reference object 106. If there is a change in temperature of the reference object, then the system 100 also subtracts the determined change in temperature of the reference object 106 from the measurement of the subject at 308.

Then, the method 300 continues at 310 by determining whether the sensor is at full operational temperature. The determination at 310 may be made based on the operational time of the camera 104, in some embodiments. Put a different way, the system 100 and control system 200 may determine whether the camera 104 has been operational for a selected minimum time based on known characteristics of the camera 104. In some embodiments, the determination at 310 is based on whether the detected fluctuations in temperature at 306 have reached a certain threshold or limit. In one non-limiting example, the control system 200 may store a selected threshold value such as detected fluctuations less than 0.2 degrees C. or more or less that occur no more than twice per minute, or more or less. If the detected fluctuations at 306 are below this threshold, then the system 100 is at full operational temperature and the method can continue. In yet further embodiments, the determination at 310 is made based on a detected temperature of the camera 104, either through a thermometer or temperature sensor in the camera 104 or through another like external device.

If the system 100 has not reached the full operational temperature, then the method 300 returns at 312 to continue the temperature measurements at 304 in a loop until the camera 104 is at full operational temperature. If the camera 104 has reached the full operational temperature, then the method 300 continues via 314. After the camera 104 has reached the full operational temperature, the dominant source of error changes from sensor drift due to heating of the camera 104 to changes in environmental temperature. In some embodiments, the camera 104 may further include a shutter that temporarily closes over the sensor array (FIG. 7) at selected intervals. When the shutter is closed, the camera 104 is calibrated by using the shutter as a base line to eliminate sensor drift. More specifically, the camera 104 has a thermal shutter in some embodiments to reduce non-linear temperature changes. In one non-limiting example, the shutter closes over the sensor array 168 at periodic intervals every 2 minutes or more or less. The system 100 knows the temperature of the shutter and expects that all of the sensors 170 will read the same temperature when the shutter is closed. Once the expected temperature of the sensors is known, the system 100 can then calibrate any sensors 170 giving a different reading to the known temperature value to eliminate sensor drift. As such, the shutter keeps the camera 104 from drifting by leveling off localized biases of each sensor or the localized drift from other sensors.

Further, the camera 104 changes temperature at a considerably lower rate after reaching the operational temperature and may, in some cases, remain relatively constant (e.g., within one to three degrees C.). As such, errors attributable to sensor drift are significantly reduced after the camera reaches the full operational temperature. Changes in environmental temperature also occur on a comparatively less frequent basis than changes due to sensor drift from heating of the camera 104. For example, the environmental temperature may change between 1 and 3 degrees C. or more or less over a period of one hour or more or less depending on conditions in one non-limiting example. As such, at 316, the system 100 determines whether the fluctuations in temperature occur at a high frequency, which indicates sensor drift, or a low frequency, which indicates a change in environment.

The low frequency changes are subtracted from the measurement of the subject 158 at 318, which is similar to step 308 described above. Then, at 320, the high frequency changes are disregarded and are not subtracted from the temperature of the subject 158. Thus, in sum, once the camera 104 reaches the full operational temperature, the method 300 of operation and measuring temperature changes to focus less on high frequency changes due to the reduction in the likelihood of error due to sensor drift and instead, considers changes in the environmental conditions as the dominate source of error that is corrected in the temperature measurements of the subject 158. The method 300 may continue from 310 back to 316 via 322 in a continuous loop until the camera 104 is deactivated. When the camera 104 is activated again, the method restarts at 302.

FIG. 10 illustrates one or more embodiments of a set of instructions that are executed by the processor 202 (FIG. 8) that cause the system 100 to perform certain functions. In other words, FIG. 10 is a diagram of an embodiment of process steps (generally indicated as 400) in an algorithm for determining temperature fluctuations in a temperature reading and correcting temperature measurements of the subject 158 based on the determined fluctuations according to the present disclosure. Unless otherwise specified, the below process steps correspond to instructions that are stored in the memory 204, 206 and executed by the microprocessor 202 of the control system 200.

The present disclosure contemplates the use of an exponential moving average algorithm, exemplified below with reference to FIG. 10, in some embodiments, to identify and separate fluctuations in temperature over periods of operation of the system 100 and subtract the fluctuations from the measured temperature of the subject 158 to determine a modified, more accurate temperature reading of the subject 158. The exponential moving average algorithm, with the selected characteristics below, has a smoothing characteristic that tends to filter out noise in the data and operates as an accurate predictor of real time conditions based on historical data. In one or more embodiments, a different denoising algorithm or combinations of algorithms could be used instead of an exponential moving average algorithm, among other options. However, for the sake of the clarity, the following description will proceed by focusing on an exponential moving average algorithm.

With reference to FIG. 10 and with continuing reference to FIGS. 1-7, the process 400 begins at 402 by executing instructions to ping the sensor array 168 for a temperature measurement over a first selected period of time. In other words, the process 400 begins at 402 by executing instructions to send an activation signal to the sensor array 168, such that the sensor array 168 begins capturing thermal image data over the first selected period of time. In some embodiments, the first selected period of time is 10 minutes or more or less. The captured thermal image data over the first selected period of time is received and stored in the control system 200. The instructions at 402 may include instructions for the continuous capture of the data from the sensor array 168 during the first selected time period, or may include instructions for capturing the sensor data over selected and distinct time sub-intervals, such as thermal image data over a one second or fraction of a second period, or more or less. Further, the instructions at 402 may include capturing the thermal image data at distinct points of time, such as every second or every fraction of a second, or more or less.

In some embodiments, when the control system 200 pings the sensor array 168, the control system 200 is requesting thermal imaging data from the portion 109 of the sensor array 168 that corresponds to the portion 107 of the reference object 106 in the line of sight 108 of the camera 104. The portion 109 of the sensor array 168 may be selected by profiling the camera 104 and selecting the portion of the array 168 that provides greatest accuracy and least variability. The location of the reference object 106 relative to the sensor array 168 may then be adjusted accordingly. Further, the control system 200 may execute instructions to determine the median of the temperature data from the sensors 170 in the portion 109 or the average of the temperature data from the sensors 170 in the portion 109, among others. In other words, in one or more embodiments, before further processing, the control system 200 may first attempt to correct the accuracy and smooth the temperature data from the individual sensors 170 in the portion 109 by determining an average or median of the data from the sensors 170 in the portion 109.

The control system 200 then executes instructions to determine the average of the temperature data over the first selected period of time at 404. The process 400 continues at 406, where the average determined in 404 is compared to the actual temperature measurement data obtained at 402 to identify fluctuations in the temperature data. In one non-limiting example, a limited data set of temperatures over the first period of time may be 22 degrees C. at 2 minutes, 22.8 degrees C. at 4 minutes, 19.7 degrees C. at 6 minutes, and 22.5 degrees C. at 8 minutes of a selected 10 minute period. At 404, the control system 200 determines that the average temperature over the selected time period is 21.75 degrees C. Then, at 406, the control system 200 executes instructions to identify fluctuations from the 21.75 degrees C. average for each individual data point in the set above. Then, the process continues at 408 by applying a weight factor to the fluctuations in temperature based on the age of the temperature data points. In some embodiments, the weight factor is based on an exponential scale that decreases in as the age of the data point increases. For instance, continuing the non-limiting example above, a weight factor for the first data point at 2 minutes may be 0.1, a weight factor for the second data point at 4 minutes may be 0.2, a weight factor for the third data point at 6 minutes may be 0.4 and a weight factor for the fourth data point at 8 minutes may be 0.8. The weight factor helps increase the accuracy of real time predictions in fluctuations in temperature using historical data.

After the weight factor is appropriately applied to each data point, the process 400 continues at 410 by the control system 200 executing instructions to determine a trend line for the weighted temperature fluctuation data over the first selected period of time. The trend line can then be used to predict the amount of temperature fluctuation for a real-time measurement of the subject 158. In other words, when the temperature of the subject 158 is to be measured, the process 400 continues at 412 by selecting a temperature fluctuation from the trend line corresponding to the timing of the measurement of the subject 158. The control system 200 then executes instructions at 414 for subtracting (or adding) the temperature fluctuation to the measured temperature of the subject 158.

When the subject 158 approaches the camera 104, the control system 200 will receive temperature data corresponding to the subject 158 via execution of the instructions at 402. Then, the control system 200 references the trend line from the weighted temperature fluctuation data at 410 to determine what adjustment to apply to the measured temperature of the subject 158. Continuing the non-limiting example above, if the subject 158 approaches the camera at the 9 minute mark of the 10 minute selected period, then the control system 200 may determine that there is a positive 0.3 degree C. fluctuation via the trend line determined at 410. If the temperate of the subject 158 is measured to be 37.4 degrees C., then the control system 200 selects 0.3 degrees C. from the trend line at 412 and subtracts, at 414, 0.3 degrees C. from the measured temperature of the subject 158 and outputs a modified or corrected temperature of the subject 158 of 37 degrees C.

Further, the process 400 may include, in some embodiments, steps for adjusting the first selected time of period to change the rate of response to changing environmental conditions. At 416, the control system 200 may execute instructions to determine whether there has been a change in the average temperature determined at 404 over a second, shorter period of time that is beyond a threshold value. In one or more embodiments, the second period of time is 1 minute, two minutes, three minutes or more or less. Further, the threshold value may be selected to be any whole number or fraction between 0 and 20 degrees C. or more. If the change in temperature over the second period of time at 416 is not greater than the threshold, then the system reverts to 402 via line 418 and continues in a loop until instructions are received to stop obtaining temperature data. If the change in average temperature over the second time period is greater than the selected threshold value, then the process 400 continues at 420 to adjust the length of the first period of time and reverts back to 402 in a continuous loop via line 422.

Adjusting the length of the first period of time will change the reduction of noise in the data as well as the responsiveness to changing environmental conditions in an inverse relationship. As such, the first selected period of time being 10 minutes in some embodiments has been determined to be an appropriate balance between denoising the thermal temperature data and responding to environmental changes. However, where the environmental conditions change rapidly, then the process 400 adjusts at 420 to shorten the first period of time, such that the rapid environmental changes are more appropriately reflected in the correction of the subject temperature when the process 400 is repeated via line 422. As such, the process 400 can be tuned by adjusting the first and second selected time periods to reduce lag in responding to environmental changes while also reducing lag. In sum, the process 400 is a modified exponential moving average with a threshold where an exponential moving average with a longer first selected period of time is used until a change in the second, shorter selected period of time is observed relative to the first period of time. If the change is within the selected threshold, then the process continues using the unmodified exponential moving algorithm. If the change is outside or beyond the selected threshold, then the first selected period of time is adjusted to increase responsiveness to environmental changes.

In some embodiments, the process 400 may also include using a comparatively shorter first selected time period of 2 minutes or more or less and storing the history of the determined exponential moving average over a second selected period, such as for the last 14 minutes or more or less. Then, the historical data can be separated into a number of intervals, such as 7 samples of 2 minutes each. The historical samples can then be used to fit a nth order polynomial, such as a third, fourth, fifth or more or less order polynomial to the historical data to predict behavior for a third period of time in the future, such as 30 seconds.

The foregoing description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with thermographic cameras have not been shown or described in order to avoid unnecessarily obscuring descriptions of the embodiments. The various embodiments described herein may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. Reference throughout this specification to “one embodiment” or “an embodiments” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

Unless the context requires otherwise, throughout the specification and claims that follow, the word “comprising” is synonymous with “including,” and is inclusive or open-ended (i.e., does not exclude additional, unrecited elements or method acts). Further, the terms “first,” “second,” and similar indicators of sequence are to be construed as interchangeable unless the context clearly dictates otherwise.

The relative terms “approximately” and “substantially,” when used to describe a value, amount, quantity, or dimension, generally refer to a value, amount, quantity, or dimension that is within plus or minus 5% of the stated value, amount, quantity, or dimension, unless the content clearly dictates otherwise. It is to be further understood that any specific dimensions of components provided herein are for illustrative purposes only with reference to the embodiments described herein, and as such, the present disclosure includes amounts that are more or less than the dimensions stated, unless the context clearly dictates otherwise.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied outside of the thermographic imaging context, and not necessarily the imaging systems and methods generally described above.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any computer-readable medium for use by or in connection with any processor-related system or method. In the context of this disclosure, a memory is a computer-readable medium that is an electronic, magnetic, optical, or other physical device or means that contains or stores a computer and/or processor program. Logic and/or the information can be embodied in any computer-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “computer-readable medium” can be any element that can store the program associated with logic and/or information for use by or in connection with the instruction execution system, apparatus, and/or device. The computer-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and other nontransitory media.

Many of the methods described herein can be performed with variations. For example, many of the methods may include additional acts, omit some acts, and/or perform acts in a different order than as illustrated or described.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device, comprising:
a case, including:
a reference object coupled to the case; and
a portion of the case spaced from the reference object by a fixed distance, wherein the portion of the case is configured to receive a thermographic camera with at least a portion of the reference object in a line of sight of the thermographic camera.

2. The device of claim 1 wherein the case further comprises:
a base;
an extension element coupled to the base, wherein the base and the extension element define a first opening; and
a cover coupled to the extension element, wherein the cover and the extension element define a second opening,
wherein the first opening is configured to receive the thermographic camera and the second opening is configured to receive the reference object.

3. The device of claim 2 wherein the base and the cover each include at least one of a plurality of connectors, each of the plurality of connectors including a protrusion and a flange extending transverse to the protrusion.

4. The device of claim 3 wherein the extension element further includes a plurality of apertures configured to receive the plurality of connectors to selectively couple the base and the cover to the extension element.

5. The device of claim 1 wherein the fixed distance is between 5 and 15 centimeters.

6. The device of claim 1 wherein the reference object is passive.

7. The device of claim 1 wherein the portion of the reference object positioned in the line of sight of the thermographic camera corresponds to between 20 and 60 pixels of an array of the thermographic camera.

8. A system, comprising:
a housing;
a thermographic camera coupled to the housing and having a line of sight;
a reference object coupled to the housing with at least a portion of the reference object positioned in the line of sight of the thermographic camera;
one or more processors; and
non-transitory memory storing a set of instructions that, as a result of execution by the one or more processors, cause the system to:
activate the thermographic camera;
obtain, with the thermographic camera, a first temperature of a subject;
obtain, with the thermographic camera, a second temperature of the reference object;
analyze the second temperature based on a known property of the reference object to generate an adjusted first temperature of the subject; and
output the adjusted first temperature of the subject.

9. The system of claim 8 wherein the instructions to analyze the second temperature further include instructions to determine a fluctuation in the second temperature based on the known property of the reference object and adjust the first temperature in real time based on the fluctuation to generate the adjusted first temperature of the subject.

10. The system of claim 8 wherein the second temperature is one a plurality of second temperatures, and the non-transitory memory stores further instructions that, as a result of execution by the one or more processors, causes the system to:
determine an average of the plurality of second temperatures over a period of time;
identify, using the average of the plurality of second temperatures, a plurality of fluctuations in the plurality of second temperatures over the period of time;
determine an exponential moving average of the plurality of fluctuations during the period of time; and
adjust the first temperature of the subject based on a trend line fit to the exponential moving average of each of the plurality of fluctuations.

11. The system of claim 8, further comprising a temperature sensor coupled to the one or more processors that is configured to detect environmental temperature, and the non-transitory memory stores further instructions that, as a result of execution by the one or more processors, causes the system to:
identify changes in the environmental temperature over time based on temperature signals received from the temperature sensor; and
adjust the first temperature and the second temperature based on identified changes in the environmental temperature.

12. The system of claim 8 wherein the reference object is spaced from the thermographic camera by a distance between 2 centimeters and 10 centimeters.

13. The system of claim 8 wherein the portion of the reference object positioned in the line of sight of the thermographic camera corresponds to between 20 and 60 pixels of an array of the thermographic camera.

14. The system of claim 8 wherein the housing further includes:
a base having a first connector;
an extension element coupled to the base, the extension element having a first aperture and a second aperture, the first connector received in the first aperture, wherein the extension element and the base define a first opening with the thermographic camera received in the first opening; and
a cover coupled to the extension element, the cover having a second connector received in the second aperture of the extension element, wherein the cover and the extension element define a second opening with the reference object received in the second opening.

15. A method, comprising:
activating a thermographic camera;
capturing, with the thermographic camera, a first temperature of a subject;
capturing, with the thermographic camera, a second temperature of a reference object;
analyzing the second temperature based on a known property of the reference object to generate an adjusted first temperature of the subject; and
outputting the adjusted first temperature.

16. The method of claim 15 wherein the analyzing the second temperature includes determining a fluctuation in the second temperature compared to an average of the second temperature over a period of time, and adjusting the first temperature based on the determined fluctuation to generate the adjusted first temperature of the subject.

17. The method of claim 15 wherein capturing the second temperature includes capturing a plurality of second temperatures, the method further comprising:
determining an average of the plurality of second temperatures during a period of time;
identifying a plurality of fluctuations in the plurality of second temperatures relative to the average over the period of time;
determining an exponential moving average for the plurality of fluctuations over the period of time; and
adjusting the first temperature of the subject based on a trend line fit to the exponential moving average of each of the plurality of fluctuations.

18. The method of claim 17 further comprising, after identifying the plurality of fluctuations in the plurality of second temperatures:
applying an attenuation factor to the plurality of fluctuations based on a difference between the first temperature and the average of the plurality of second temperatures.

19. The method of claim 15 wherein capturing the first temperature of the subject includes capturing the first temperature after a warm-up time period following activating the thermographic camera.

20. The method of claim 15 wherein capturing the first temperature includes capturing temperature data corresponding to a first area of the subject and capturing the second temperature includes capturing temperature data corresponding to a second area of the reference object, wherein the first area and the second area are approximately equal.
